(19) United States
(12) Patent Application Publication
(10) Pub. No.: US 2024/0086303 A1
(43) Pub. Date: Mar. 14, 2024

(54) Formal Verification of a Program of a Control Device

(71) Applicant: Bayerische Motoren Werke Aktiengesellschaft, Muenchen (DE)

(72) Inventor: Vladislav NENCHEV, Muenchen (DE)

(21) Appl. No.: 18/263,286

(22) PCT Filed: Dec. 3, 2021
(86) PCT No.: PCT/EP2021/084171

§ 371 Date: Jul. 27, 2023

(30) Foreign Application Priority Data
Jan. 28, 2021 (DE) 10 2021 101 876.5

(51) Int. Cl. G06F 11/36

(52) U.S. Cl. CPC G06F 11/3608

(57) ABSTRACT

A method for formal verification of a program of a control device. A graph model of the program of the control device and a specification to be fulfilled by the program of the control device are provided. A Kripke structure is determined as a function of the graph model of the program of the control device. It is checked whether the Kripke structure fulfills the specification to be fulfilled by the program of the control device.

This application is a 371 of International Application No. PCT/EP2021/084171, filed Dec. 3, 2021 which claims priority under 35 U.S.C. § 119 from German Patent Application No. 10 2021 101 876.5, filed Jan. 28, 2021, the entire disclosure of which is herein expressly incorporated by reference.

### BACKGROUND AND SUMMARY OF THE INVENTION

The invention relates to a method and a device for formal verification of a program of a control device.

The formal verification of programs for control devices is known from the prior art. Formal verification of a program is the proof that the program includes all properties required in a specification.

The creation of a representation of the program suitable for the formal verification is, however, a manual, complex, and error-prone activity.

It is therefore the object of the invention to specify a method and a corresponding device, using which the formal verification of a program can be carried out in an automated manner.

The object is achieved by the features of the independent claims. Advantageous embodiments are described in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

A first aspect of the invention relates to a method for formal verification of a program of a control device, in particular a control device for a motor vehicle.

Formal verification is in this case the formal proof of the correctness of the program of the control device, or the proof that the program of the control device includes all required properties.

One step of the method is that of providing a graph model of the program of the control device.

The graph model is an abstract structure, which represents a set of objects together with the connections existing between these objects. The mathematical abstractions of the objects are called nodes of the graph in this case. The paired connections between nodes are called edges. The edges can be directed or undirected.

The graph model of the program of the control device represents a model of the behavior of the program of the control device here. The nodes of the graph model correspond to internal states of the program of the control device. The edges of the graph model correspond to transitions between the internal states of the program of the control device.

The edges of the graph model each specify in particular at least one condition here, which has to be present so that the respective state transition takes place.

The graph model is in particular a state machine.

A further step of the method is that of providing a specification to be fulfilled by the program of the control device. This specification to be fulfilled by the program of the control device describes the properties to be fulfilled by the program of the control device, wherein these properties are specified, for example, by a developer of the program.

A further step of the method is that of determining a Kripke structure as a function of the graph model of the program of the control device.

A Kripke structure is a directed graph, which is defined by the four tuple (S, S₀, R, L):
S: a finite set of states,
S₀: a set of initial states and a subset of S,
R: a transition relation between the states from S, and
L: a label function, which maps a state onto the atomic logical statements applicable in this state. The applicable atomic logical statements assigned to a state via the label function L are designated hereinafter as “labels”.

A further step of the method is that of checking whether the Kripke structure fulfills the specification to be fulfilled by the program of the control device.

This can be carried out, for example, by means of the method of model checking known from the prior art, which is suitable for checking the Kripke structure for fulfilling the specification to be fulfilled.

In one advantageous embodiment of the invention, determining the Kripke structure as a function of the graph model of the program of the control device comprises the step of checking whether a node of the graph model of the program of the control device is reachable upon the presence of a pre-condition.

A pre-condition in this case is a condition which can result in a state transition in the graph model of the program of the control device. In this advantageous embodiment, conditions are taken into consideration which are assigned to the edges incoming at the node.

For better readability, in particular with respect to a further advantageous embodiment which will be described later, these conditions, which are assigned to the edges incoming at the node, are designated as “pre-conditions”.

In other words, this step of the method describes whether the node of the graph model is reachable via an incoming edge.

A further step of this advantageous embodiment of the invention is that of generating a node of the Kripke structure using the node of the graph model of the program of the control device and the pre-condition as labels, if the node of the graph model of the program of the control device is reachable upon the presence of the pre-condition.

In particular when these steps can be carried out for all nodes of the graph model, all nodes of the Kripke structure and its labels can thus be generated.

In a further advantageous embodiment of the invention, determining the Kripke structure as a function of the graph model of the program of the control device comprises the step of ascertaining whether a second node of the graph model of the program of the control device is reachable from a first node of the graph model of the program of the control device upon the presence of a post-condition.

A post-condition is in this case a condition which can result in a state transition in the graph model of the program of the control device. In this advantageous embodiment, conditions are taken into consideration here which are assigned to the edges outgoing at the node.

For better readability, in particular with respect to the pre-conditions introduced in a further advantageous embodiment, these conditions which are assigned to the edges outgoing at the node are designated as “post-conditions”.

In other words, the terms “pre-condition” and “post-condition” designate the same elements of the graph model of the program of the control device, namely the conditions assigned to the edges. The different designations are used exclusively for better readability.

A further step of this advantageous embodiment of the invention is that of generating an edge in the Kripke structure starting from the node in the Kripke structure, the labels of which comprise the first node of the graph model of the program of the control device, to the node in the Kripke structure, the labels of which comprise the second node of the graph model of the program of the control device and the post-condition, if the second node of the graph model of the program of the control device is reachable from the one first node of the graph model of the program of the control device upon the presence of the post-condition.

In other words, an edge is generated in the Kripke structure when a second node is reachable from the first node in the graph structure via an edge.

This edge in the Kripke structure originates from the node in the Kripke structure, the labels of which comprise the first node of the graph model of the program of the control device. This edge in the Kripke structure leads to the node in the Kripke structure, the labels of which comprise the second node of the graph model of the program of the control device and the post-condition of the edge in the graph model of the program of the control device. It is therefore a uniquely definable, directed edge.

To identify the node in the Kripke structure to which the edge in the Kripke structure leads, in particular the labels of all nodes of the Kripke structure are checked.

In particular when these steps can be carried out for all nodes of the graph model, all edges of the Kripke structure can thus be generated.

In a further advantageous embodiment of the invention, providing the graph model of the program of the control device comprises the step of generating a track of input signals for the program of the control device, wherein the track of input signals for the program of the control device comprises at least one condition which causes a state transition of the program of the control device.

The input signals for the program of the control device are in particular discrete and known in this case.

Generating the track of input signals for the program of the control device can be carried out, for example, by a, possibly random, selection of elements from the known set of the input signals for the program of the control device.

A further step of this advantageous embodiment of the invention is that of stimulating the program of the control device using the track of input signals for the program of the control device.

The program of the control device itself in particular represents a so-called “black box” here, the content of which is not known from the viewpoint of the method according to the invention.

Stimulating the program of the control device using the track of input signals for the program of the control device means in other words that the elements of the track of input signals for the program of the control device are sequentially transferred to the program of the control device as input signals.

A further step of this advantageous embodiment of the invention is accepting an item of information about the current state of the program of the control device after stimulating the program of the control device using the track of input signals for the program of the control device.

In particular if the program of the control device does not output information about the current state of the program of the control device after the stimulation of the program of the control device using the track of input signals, or this information indicates that the current input signal results in its state transition, the next element of the track of input signals can already be transferred to the program of the control device at this point, since in this case it is already uniquely defined at this point that for the current state of the program of the control device and current input signal, no element has to be generated in the graph model.

In particular, the information about the current state of the program of the control device is the current state of the program of the control device itself.

A further step of this advantageous embodiment of the invention is that of generating the graph model of the program of the control device as a function of the track of input signals and of the information about the current state of the program of the control device.

Generating the graph model of the program of the control device as a function of the track of input signals and of the information about the current state of the program of the control device can in particular be carried out in such a way that a node is generated in the graph model for each observed state of the program of the control device.

The edges in the graph model result from the sequences of observed state transitions of the observed state of the program of the control device, wherein the input signal triggering the respective state transition is usable as a condition of the respective edge in the graph model.

In a further advantageous embodiment of the invention, the track of input signals for the program of the control device comprises at least two conditions, each of which causes a state transition of the program of the control device, and the information about the current state of the program of the control device identifies at least one state of the program of the control device non-uniquely.

In this advantageous embodiment of the invention, generating the graph model of the program of the control device as a function of the track of input signals and of the information about the current state of the program of the control device comprises the step of determining a set of possible states of the program for the information about the current state of the program of the control device.

A further step of this advantageous embodiment of the invention is that of removing at least one element of the set of possible states of the program of the control device as a function of the sequence of the items of information about the current state of the program of the control device which are output by the program of the control device in reaction to the stimulation of the program of the control device using the track of input signals.

Thus, for example, by evaluating the sequence of the by the program of the control device in reaction to the stimulation of the program of the control device using the track of input signals, different internal states of the program of the control device may be distinguished, although they possibly result in the output of the same information about the current state of the program of the control device.

This results because the pre-conditions and post-conditions of these states differ from one another and thus with tracks of input signals becoming longer and longer, the set of the associated internal states of the program with the corresponding state in the Kripke structure will become smaller and smaller, which is in particular because of the repeated calculation of the post-condition and its combination with the information about the current state of the program of the control device.

A second aspect of the invention relates to a device for formal verification of a program of a control device, wherein the device is configured to provide a graph model of the program of the control device, to provide a specification to be fulfilled by the program of the control device, to determine a Kripke structure as a function of the graph model of the program of the control device, and to check whether the Kripke structure fulfills the specification to be fulfilled by the program of the control device.

The above statements on the method according to the invention according to the first aspect of the invention also apply in a corresponding manner to the device according to the invention according to the second aspect of the invention. Advantageous exemplary embodiments of the device according to the invention which are not explicitly described at this point and in the claims correspond to the advantageous exemplary embodiments of the method according to the invention described above or described in the claims.

The invention will be described hereinafter on the basis of an exemplary embodiment with the aid of the appended drawings.

### BRIEF DESCRIPTION OF THE DRAWINGS

FIG. 1 shows an exemplary embodiment of a graph model GM according to the invention,

FIG. 2 shows an exemplary embodiment of a Kripke structure KS corresponding to the graph model GM shown in FIG. 1, and

FIG. 3 shows an exemplary embodiment of the method according to the invention.

### DETAILED DESCRIPTION OF THE DRAWINGS

The above described drawing figures illustrate aspects of the invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one embodiment of the invention with the understanding that the present disclosure is to be considered as an exemplification of the principles of the invention, and is not intended to limit the broad aspects of the invention to any embodiment illustrated. It will therefore be understood that what is illustrated is set forth for the purposes of example, and should not be taken as a limitation on the scope of the present invention.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the invention. Thus, the appearances of such phrases in various places throughout this specification are not necessarily all referring to the same embodiment.

Furthermore, the particular features, structures, or characteristics may be combined in any suitable manner on one or more embodiments without limitation. The term “or” as used herein is to be interpreted as inclusive or meaning any one or any combination.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the invention. However, it should be appreciated that the invention may be practiced without such specific details. Additionally, for brevity sake well-known methods, procedures, components, and circuits have not been described in detail.

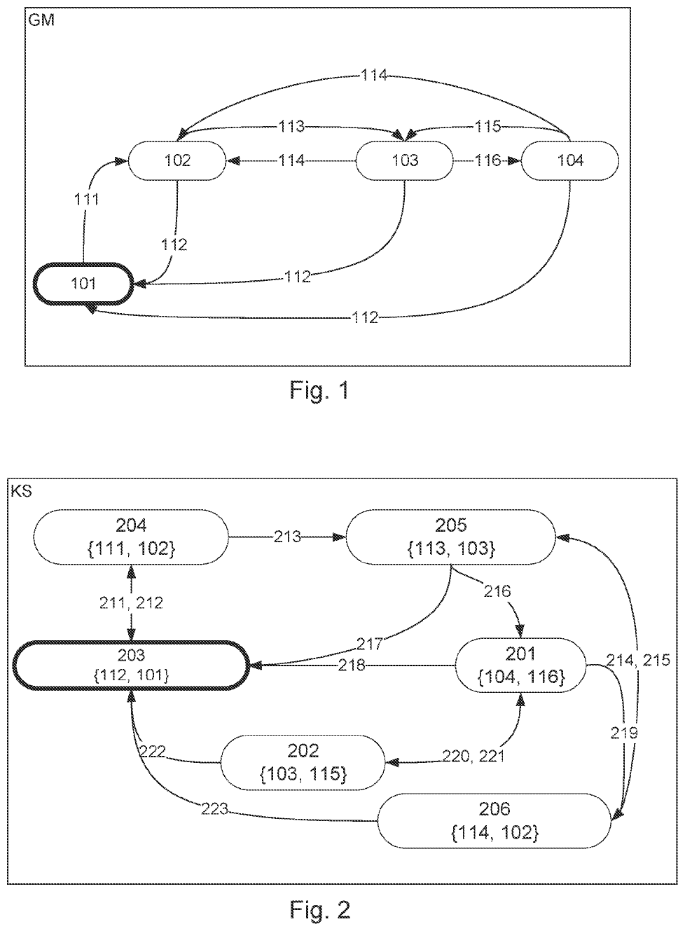

FIG. 1 shows an exemplary embodiment of a graph model GM according to the invention.

For example, it is a graph model GM of a driver assistance system of a motor vehicle, which comprises the following states as nodes:
101: not available,
102: standby,
103: available, and
104: active.

The starting state 101 is graphically highlighted here.

The state transitions of the driver assistance system are triggered by the following input signals, which are represented in the graph model GM as conditions of edges:
111: error-free,
112: error,
113: environment okay,
114: environment not okay,
115: off, and
116: on.

The graph model is not a complete graph here, all nodes are thus not directly connected to one another via an edge. Accordingly, every condition also does not activate a state transition to another node in each node.

If the graph model GM is in the state 101 “not available”, for example, the condition 111 “error-free” thus triggers a state transition into the state 102 “standby”. However, in the state 101 “not available”, the condition 113 “environment okay” does not trigger a state transition, since no edge originating from the node 101 is linked to the condition 103.

FIG. 2 shows an exemplary embodiment of a Kripke structure KS corresponding to the graph model GM shown in FIG. 1.

The Kripke structure KS shown in FIG. 2 is determined by the method according to the invention as a function of the graph model GM of the program PC of the control device SG.

The starting state 203 is graphically highlighted here.

The determination of the Kripke structure KS as a function of the graph model GM of the program PC of the control device SG comprises the step of checking whether a node 101, 102, 103, 104 of the graph model GM of the program PC of the control device SG is reachable upon the presence of a pre-condition 111, 112, 113, 114, 115, 116.

In other words, it is checked whether a node 101, 102, 103, 104 of the graph model GM is reachable via an incoming edge.

A further step of the method is generating a node 201, 202, 203, 204, 205, 206 in the Kripke structure KS using the node 101, 102, 103, 104 of the graph model GM of the program PC of the control device SG and the pre-condition 111, 112, 113, 114, 115, 116 as labels if the node 101, 102, 103, 104 of the graph model GM of the program PC of the control device SG is reachable upon the presence of the pre-condition 111, 112, 113, 114, 115, 116.

In the present example, the node 104 of the graph model GM is reachable via an incoming edge upon the presence of the condition 116. Therefore, the node 201 is generated in the Kripke structure KS. This is assigned the labels 104 and 116, thus the node 104 reachable in the graph model GM and the pre-condition 116 from the graph model.

The node 103 of the graph model GM is reachable via an incoming edge upon the presence of the condition 115. Therefore, the node 202 is generated in the Kripke structure KS. This is assigned the labels 103 and 115, analogously to the procedure at node 201.

The node 101 of the graph model GM is reachable via an incoming edge upon the presence of the condition 112. Therefore, the node 203 is generated in the Kripke structure KS. This is assigned the labels 101 and 112, analogously to the procedure at node 201.

The node 102 of the graph model GM is reachable via an incoming edge upon the presence of the condition 111. Therefore, the node 204 is generated in the Kripke structure KS. This is assigned the labels 102 and 111, analogously to the procedure at node 201.

The node 103 of the graph model GM is reachable via an incoming edge upon the presence of the condition 113. Therefore, the node 205 is generated in the Kripke structure KS. This is assigned the labels 103 and 113, analogously to the procedure at node 201.

The node 102 of the graph model GM is reachable via an incoming edge upon the presence of the condition 114. Therefore, the node 206 is generated in the Kripke structure KS. This is assigned the labels 102 and 114, analogously to the procedure at node 201.

The nodes of the Kripke structure KS were then completely generated when all pre-conditions 111, 112, 113, 114, 115, 116 of all nodes 101, 102, 103, 104 of the graph model GM of the program PC of the control device SG were taken into consideration.

Determining the Kripke structure KS as a function of the graph model GM of the program PC of the control device SG comprises the further step of determining whether a second node 101, 102, 103, 104 of the graph model GM of the program PC of the control device SG is reachable from a first node 101, 102, 103, 104 of the graph model GM of the program PC of the control device SG upon the presence of a post-condition 111, 112, 113, 114, 115, 116.

If the second node 101, 102, 103, 104 of the graph model GM of the program PC of the control device SG is reachable from the one first node 101, 102, 103, 104 of the graph model GM of the program PC of the control device SG upon the presence of the post-condition 111, 112, 113, 114, 115, 116, an edge 211, 212, 213, 214, 215, 216, 217, 218, 219, 220, 221, 222, 223 is generated in the Kripke structure KS originating from the node 201, 202, 203, 204, 205, 206 in the Kripke structure KS, the labels of which comprise the first node 101, 102, 103, 104 of the graph model GM of the program PC of the control device SG, to the node 201, 202, 203, 204, 205, 206 in the Kripke structure KS, the labels of which comprise the second node 101, 102, 103, 104 of the graph model GM of the program PC of the control device SG and the post-condition 111, 112, 113, 114, 115, 116.

For the sake of clarity, only one edge was shown in FIG. 2 between two nodes, which are directly connected by edges in the direction of each of the two nodes, which is identified at each end with an arrow, however. For example, the nodes 203 and 204 are connected by the edges 211 and 212, wherein the illustration in FIG. 2 is to be understood to mean that the edge 211 leads from node 203 to node 204 and the edge 212 leads in the opposite direction from node 204 to node 203. This also applies to edges 214 and 215, which connect the nodes 205 and 206, and to edges 220 and 221, which connect the nodes 201 and 202.

In the present example, the second node 102 is reachable in the graph model GM from the first node 101 upon the presence of the post-condition 111. An edge 211 is therefore generated in the Kripke structure KS. The edge 211 leads away from the node of the Kripke structure KS, the labels of which comprise the first node 101. The node 203 is therefore the starting point of the edge 211. The edge 211 leads to the node of the Kripke structure KS, the labels of which comprise the second node 102 of the graph model GM and the post-condition 111. The node 204 is therefore the end point of the edge 211.

The node 101 is reachable in the graph model GM from the node 102 upon the presence of the post-condition 112. Analogously to the edge 211, the edge 212 is therefore generated in the Kripke structure KS. The edge 212 leads away from the node of the Kripke structure KS, the labels of which comprise the first node 102. The node 204 is therefore the starting point of the edge 212. The edge 212 leads to the node of the Kripke structure KS, the labels of which comprise the second node 101 of the graph model GM and the post-condition 112. The node 203 is therefore the end point of the edge 212.

The node 103 is reachable in the graph model GM from the node 102 upon the presence of the post-condition 113. Analogously to the edges 211 and 212, the edge 213 is therefore generated in the Kripke structure KS. The edge 213 leads away from the node of the Kripke structure KS, the labels of which comprise the first node 102. The node 204 is therefore the starting point of the edge 213. The edge 213 leads to the node of the Kripke structure KS, the labels of which comprise the second node 103 of the graph model GM and the post-condition 113. The node 205 is therefore the end point of the edge 213.

In addition, the edges 214-223 are generated analogously to the edges 211, 212, and 213.

The edges of the Kripke structure KS were completely generated when all post-conditions 111, 112, 113, 114, 115, 116 of all nodes 101, 102, 103, 104 of the graph model GM of the program PC of the control device SG have been taken into consideration.

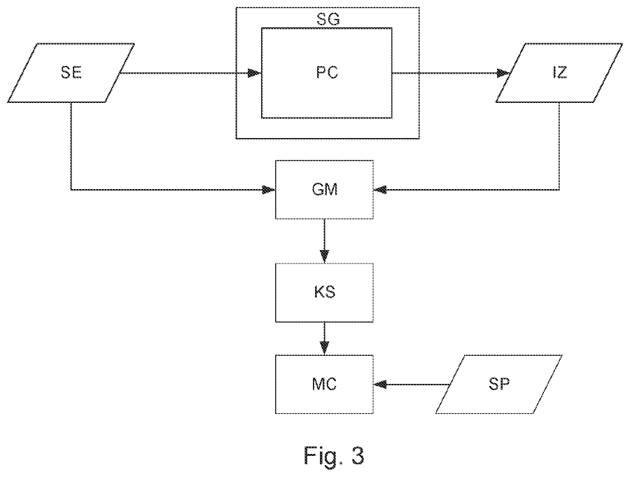

FIG. 3 shows an exemplary embodiment of the method according to the invention for formal verification of a program PC of a control device SG.

One step of the method is that of providing a graph model GM of the program PC of the control device SG.

Providing the graph model GM of the program PC of the control device SG comprises the step of generating a track SE of input signals for the program PC of the control device SG, wherein the track SE of input signals for the program PC of the control device SG comprises at least one condition 111, 112, 113, 114, 115, 116, which causes a state transition of the program PC of the control device SG.

A further step of providing the graph model GM of the program PC of the control device SG is that of stimulating the program PC of the control device SG using the track SE of input signals for the program PC of the control device SG.

A further step of providing the graph model GM of the program PC of the control device SG is that of accepting an item of information IZ about the current state 101, 102, 103, 104 of the program PC of the control device SG after stimulating the program PC of the control device SG using the track SE of input signals for the program PC of the control device SG.

The graph model GM of the program PC of the control device SG is then generated as a function of the track SE of input signals and of the information IZ about the current state 101, 102, 103, 104 of the program PC of the control device SG.

If the program PC of the control device SG is, for example, in the state 103 “available” and is stimulated using the input signal 116 “on”, an item of information IZ about the current state of the program PC of the control device SG is output, which is characteristic for the state 104 “active”, or the state 104 “active” is possibly output directly.

With this knowledge, an edge from the node 103 to the node 104 having the condition 116 can be incorporated in the graph model. If the node 104 is not yet present in the graph model at this point in time, the node 104 can also be incorporated first.

If the information IZ about the current state 101, 102, 103, 104 of the program PC of the control device SG does not uniquely identify at least one state 101, 102, 103, 104 of the program PC of the control device SG, the graph model GM can nonetheless be generated.

For this purpose, it is necessary for the track SE of input signals for the program PC of the control device SE to comprise at least two conditions 111, 112, 113, 114, 115, 116, each of which causes a state transition of the program PC of the control device SG.

In this case, first a set of possible states 101, 102, 103, 104 of the program PC can be generated for the information IZ about the current state 101, 102, 103, 104 of the program PC of the control device SG.

If, for example, the information IZ about the current state 101, 102, 103, 104 of the program of the control device SG is identical for the state 101 “not available” and for the state 102 “standby”, in a first step, the set {101, 102} can be incorporated as possible states for both positions in the graph model.

In a further step, at least one element of the set of possible states 101, 102, 103, 104 of the program PC of the control device SG is removed as a function of the sequence of the items of information IZ, output by the program PC of the control device SG in reaction to the stimulation of the program PC of the control device SG using the track SE of input signals, about the current state 101, 102, 103, 104 of the program PC of the control device SG.

The state 102 can thus be uniquely identified and the state 101 can be removed from the corresponding set {101, 102} of possible states 101, 102, 103, 104 if, starting from the set {101, 102}, the program PC of the control device SG is stimulated using the track SE of input signals {112, 111}.

A further step of the method is that of providing a specification SP to be fulfilled by the program PC of the control device SG.

A further step of the method is that of determining a Kripke structure KS as a function of the graph model GM of the program PC of the control device SG.

A further step of the method is checking whether the Kripke structure KS fulfills the specification SP to be fulfilled by the program PC of the control device SG, for example by means of a model checker MC.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

1.-6. (canceled)

7. A method for formal verification of a program of a control device, comprising:
providing a graph model of the program of the control device;
providing a specification to be fulfilled by the program of the control device;
determining a Kripke structure as a function of the graph model of the program of the control device; and
checking whether the Kripke structure fulfills the specification to be fulfilled by the program of the control device.

8. The method of claim 7, wherein determining the Kripke structure as a function of the graph model of the program of the control device comprises:
checking whether a node of the graph model of the program of the control device is reachable upon the presence of a pre-condition; and
generating a node in the Kripke structure using the node of the graph model of the program of the control device and the pre-condition as labels if the node of the graph model of the program of the control device is reachable upon the presence of the pre-condition.

9. The method of claim 7, wherein determining the Kripke structure as a function of the graph model of the program of the control device comprises:
determining whether a second node of the graph model of the program of the control device is reachable from a first node of the graph model of the program of the control device upon the presence of a post-condition; and
generating an edge in the Kripke structure originating from the node in the Kripke structure, the labels of which comprise the first node of the graph model of the program of the control device, to the node in the Kripke structure, the labels of which comprise the second node of the graph model of the program of the control device and the post-condition, if the second node of the graph model of the program of the control device is reachable from the one first node of the graph model of the program of the control device upon the presence of the post-condition.

10. The method of claim 7, wherein providing the graph model of the program of the control device comprises the following steps:
generating a track of input signals for the program of the control device, wherein the track of input signals for the program of the control device comprises at least one condition, which causes a state transition of the program of the control device;
stimulating the program of the control device using the track of input signals for the program of the control device;
accepting an item of information about the current state of the program of the control device after stimulating the program of the control device using the track of input signals for the program of the control device; and
generating the graph model of the program of the control device as a function of the track of input signals and of the information about the current state of the program of the control device.

11. The method according to claim 10,
wherein the track of input signals for the program of the control device comprises at least two conditions, which each cause a state transition of the program of the control device,
wherein the information about the current state of the program of the control device does not uniquely identify at least one state of the program of the control device, and
wherein generating the graph model of the program of the control device as a function of the track of input signals and of the information about the current state of the program of the control device comprises the following steps:
determining a set of possible states of the program for the information about the current state of the program of the control device; and
removing at least one element of the set of possible states of the program of the control device as a function of the sequence of the items of information about the current state of the program of the control device, which are output by the program of the control device in reaction to stimulating the program of the control device using the track of input signals.

12. A device for formal verification of a program of a control device, comprising:
a processor; and a memory having computer readable instructions stored thereon that, when read by the processor, configure the processor to:
provide a graph model of the program of the control device,
provide a specification to be fulfilled by the program of the control device,
determine a Kripke structure as a function of the graph model of the program of the control device, and
to check whether the Kripke structure fulfills the specification to be fulfilled by the program of the control device.
